(19) United States
(12) Patent Application Publication
(10) Pub. No.: US 2026/0220807 A1
(43) Pub. Date: Jul. 30, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tomoyori IWAO, Tokyo (JP)

(21) Appl. No.: 19/455,948

(22) Filed: Jan. 22, 2026

(30) Foreign Application Priority Data
Jan. 27, 2025 (JP) 2025-011334

(51) Int. Cl. G06T 7/70; G06T 15/08

(52) U.S. Cl. CPC G06T 7/70; G06T 15/08; G06T 2207/20081; G06T 2207/20084

(57) ABSTRACT

An image processing apparatus obtains captured images obtained by performing image capturing on a three-dimensional space to be learned from directions, sets learning target spaces in the three-dimensional space, assigns, for each learning target space, a learning model to be used to estimate a three-dimensional field of the learning target space, sets, for each learning target space, a termination condition of training of the learning model, and estimates, based on the termination condition, the three-dimensional field by performing training on the learning model using the captured images, wherein, in a case where learning models include a trained learning model satisfying the termination condition and a learning model still in training not satisfying the termination condition, the image processing apparatus performs training on the learning model still in training using a feature pertaining to the trained learning model.

### BACKGROUND

### Field of the Technology

The present disclosure relates to a technique of estimating a three-dimensional field pertaining to a three-dimensional space.

### Description of the Related Art

There is a technique of estimating a three-dimensional field corresponding to a scene in a three-dimensional space being an image capturing target, using a plurality of captured images obtained through image capturing from a plurality of viewpoint different from one another (hereinafter, will be referred to as “multi-viewpoint images”). There is also a technique of generating, using an estimated three-dimensional field, an image corresponding to the appearance of a scene from a given virtual viewpoint (hereinafter, will be referred to as “virtual viewpoint”) (hereinafter, will be referred to as “virtual viewpoint image”). “NeRF: Representing Scene As Neural Radiance Fields For View Synthesis” (hereinafter, will be referred to as “Non Patent Literature 1”) discloses, as an example of a technique of estimating a three-dimensional field, a technique of estimating radiance fields by means of Neural Radiance Fields (NeRF) that is constituted by a deep-learning neural network. Making an input of virtual viewpoint information indicating the position of a given virtual viewpoint and a viewing direction at the virtual viewpoint into a trained NeRF obtained as a result of training the NeRF using the multi-viewpoint images gives a virtual viewpoint image corresponding to the appearance of a scene from the virtual viewpoint. Specifically, the trained NeRF receiving the input of the virtual viewpoint information estimates color values and volume densities (hereinafter, will be simply called “densities”) corresponding to the scene. The integrations of the color values and the densities give pixel values of the virtual viewpoint image. Here, the density is an index representing the opacity of color.

The training of an NeRF involves the repetitive execution of the following series of processes. First, image capturing viewpoint information including information indicating the positions of image capturing devices (hereinafter, will be referred to as “image capturing positions”) and the optical axis direction of the image capturing devices (hereinafter, will be referred to as “orientation”) is input into an NeRF still in training. The NeRF executes a process similar to the above-described process of generating the virtual viewpoint image based on the input image capturing viewpoint information, thus generating images corresponding to captured images obtained through image capturing by the image capturing devices. Then, using data on the captured images as training data, the weight parameters of a neural network constituting the NeRF are updated such that the difference between the pixel values of the captured images and the pixel values of the images generated by the NeRF decreases. Unfortunately, the estimation of the radiance fields with an NeRF with high accuracy needs a vast amount of computation.

“DeRF: Decomposed Radiance Fields” (hereinafter, will be referred to as “Non Patent Literature 2”) discloses a technique of training small-scale NeRFs that are assigned to a plurality of spaces into which an image capturing space is decomposed (hereinafter, will be referred to as “decomposed spaces”) using Decomposed Radiance Fields (DeRF). Decreasing the scales of NeRFs used in training, the technique disclosed in Non Patent Literature 2 may reduce the total amount of computation needed to estimate a three-dimensional field.

### SUMMARY

The inventor found that, in the DeRF, NeRFs assigned to the decomposed spaces are uniformly trained irrespective of the importance of the decomposed spaces. The inventor thus found that DeRF involves unnecessary training on a decomposed space having a low importance in a case of, for example, performing training sufficiently to increase the estimation accuracy of a three-dimensional field in a decomposed space having a high importance. As above, the inventor found the possibility that the DeRF may increase the total amount of computation needed to estimate a three-dimensional field.

An image processing apparatus according to the present disclosure includes one or more hardware processors; and one or more memories storing one or more programs configured to be executed by the one or more hardware processors, the one or more programs including instructions for: obtaining a plurality of captured images obtained by performing image capturing on a three-dimensional space to be learned from a plurality of directions; setting a plurality of learning target spaces in the three-dimensional space, assigning, for each learning target space of the learning target spaces, a learning model to be used to estimate a three-dimensional field of the learning target space, and setting, for each learning target space of the learning target spaces, a termination condition of training of a learning model assigned to the learning model; estimating, based on the termination condition, the three-dimensional field by performing training on a learning model assigned to each learning target space of the learning target spaces using the plurality of captured images; and performing, in a case where learning models assigned to the learning target spaces include one or more trained learning models and one or more learning models still in training, training on the one or more learning models still in training while performing training on the learning target space to which one of the one or more trained learning models is assigned, using a feature pertaining to the one of the one or more trained learning models, the trained learning models satisfying the termination condition, the learning models still in training not satisfying the termination condition.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of the configuration of an image capturing system according to Embodiment 1;

FIG. 2 is a block diagram illustrating an example of the hardware configuration of an image processing apparatus according to Embodiment 1;

FIG. 3A to FIG. 3D are diagrams and a graph for describing the outline of a method for estimating the three-dimensional field in the image processing apparatus according to Embodiment 1;

FIG. 4 is a block diagram illustrating an example of the functional configuration of the image processing apparatus according to Embodiment 1;

FIG. 5 is a flowchart illustrating an example of a processing flow of the image processing apparatus according to Embodiment 1;

FIG. 6 is a flowchart illustrating an example of the flow of a training process in a training unit according to Embodiment 1;

FIG. 7A to FIG. 7C are diagrams for describing examples of the features of NeRFs according to Embodiment 1;

FIG. 8 is a diagram for describing an example of the training process in the training unit according to Embodiment 1;

FIG. 9 is a flowchart illustrating an example of a processing flow of an image processing apparatus according to Embodiment 2; and

FIG. 10 is a flowchart illustrating an example of the flow of a training process in a training unit according to Embodiment 2.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### Embodiment 1

In Embodiment 1, an aspect in which the number of training iterations is set to each of decomposed spaces into which a three-dimensional space that is a target of estimating a three-dimensional field is decomposed, for a learning model for the estimation of the three-dimensional field (hereinafter, will be referred to as “three-dimensional field model”) assigned to the decomposed space will be described. In Embodiment 1, an aspect in which a trained three-dimensional field model is utilized for a decomposed space on which the training for a predetermined number of iterations has been completed will also be described.

### <Configuration of Image Capturing System>

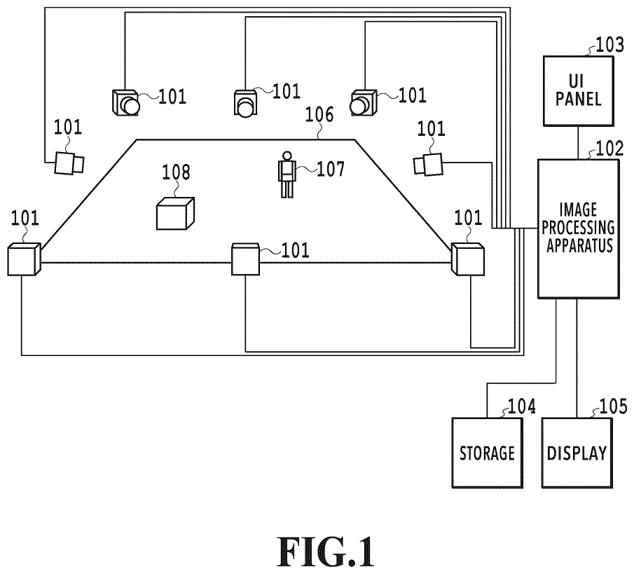

FIG. 1 is a diagram illustrating an example of the configuration of an image capturing system according to Embodiment 1. The image capturing system includes a plurality of image capturing devices 101, an image processing apparatus 102, a user interface (hereinafter, will be denoted as “UI”) panel 103, a storage 104, and a display 105. The image capturing devices 101 are each constituted by a digital still camera, a digital video camera, or the like, and are disposed at locations that are different from one another. The image capturing devices 101 perform synchronous image capturing on objects 107 and 108, which are present in an image capturing space 106, from points of view different from one another, according to set image capturing conditions. The image capturing devices 101 each output captured image data obtained through the image capturing.

Note that the synchronous image capturing means image capturing undergoing synchronous processing. The synchronous image capturing includes image capturing performed at time points that are substantially the same. The captured image data obtained through the image capturing by the image capturing devices 101 may be data on a still image, data on a moving image, or data on both a still image and a moving image. In the following description, it is assumed that the term “image” includes both meanings of “still image” and “moving image,” unless otherwise stated. The captured image data generated by image capturing devices 101 is transmitted to the image processing apparatus 102. The present embodiment will be described on the assumption that plurality of image capturing devices 101 are connected to the image processing apparatus 102, as illustrated in FIG. 1. However, how to connect the image capturing devices 101 to the image processing apparatus 102 is not limited to this. Specifically, for example, the plurality of image capturing devices 101 may be cascaded by connecting adjacent image capturing devices 101 together, and at least one of the plurality of image capturing devices 101 may be connected to the image processing apparatus 102.

The UI panel 103 includes a display device such as a liquid crystal panel and displays, on the display device, a graphical user interface (GUI) for presenting information such as the image capturing conditions for the image capturing devices 101, processing conditions for the image processing apparatus 102, and the like. The UI panel 103 may also include an input device such as a touch-sensitive panel or buttons. In this case, the UI panel 103 accepts, via the input device, an instruction from a user pertaining to the setting or changing of the above-described image capturing conditions or processing conditions. The UI panel 103 may also accept an instruction from the user pertaining to the settings of virtual viewpoints for generating a virtual viewpoint image based on an estimated three-dimensional field. Note that the user need not make an input with the input device included in the UI panel 103. For example, the user may make an input with an input device connected to the UI panel 103, the image processing apparatus 102, or the like, such as a mouse or a keyboard.

The storage 104 is constituted by a hard disk drive or the like and stores the captured image data obtained through the synchronous image capturing by the image capturing devices 101 and information about the estimated three-dimensional field for the objects 107 and 108 that is output from the image processing apparatus 102. The storage 104 may also store data on the virtual viewpoint image output from the image processing apparatus 102. The display 105 is constituted by a liquid crystal display or the like and displays the virtual viewpoint image that is generated and output by the image processing apparatus 102 based on the estimated three-dimensional field and a set virtual camera path.

The image processing apparatus 102 obtains data on a plurality of captured images (multi-viewpoint images) that are transmitted from the plurality of image capturing devices 101 and estimates, using the obtained multi-viewpoint images, a three-dimensional field corresponding to a three-dimensional space that includes the objects 107 and 108 present in the image capturing space 106. Information on the three-dimensional field estimated by the image processing apparatus 102 is output to the storage 104. The image processing apparatus 102 also generates the virtual viewpoint image based on the estimated three-dimensional field and the set virtual camera path. The virtual camera path is data including information that indicates the position of a virtual viewpoint and a viewing direction at the virtual viewpoint (hereinafter, will be referred to as “direction at virtual viewpoint”) in a time-series manner. The virtual viewpoint image generated by the image processing apparatus 102 is output to the storage 104, the display 105, or the like.

### <Hardware Configuration of Image Processing Apparatus>

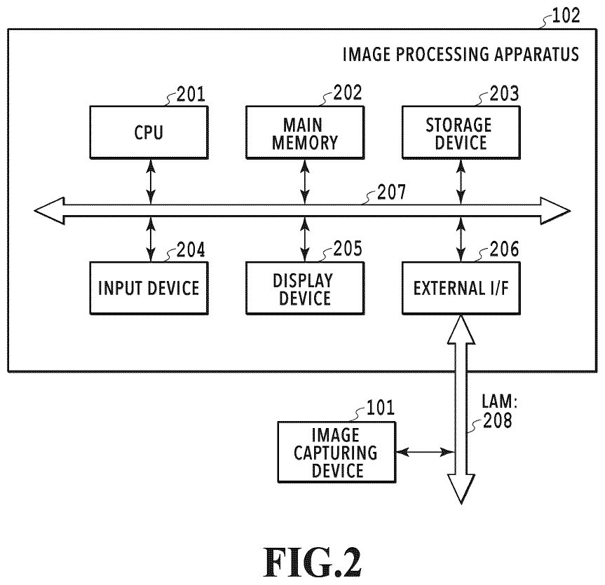

FIG. 2 is a block diagram illustrating an example of the hardware configuration of the image processing apparatus 102 according to Embodiment 1. As its hardware configuration, the image processing apparatus 102 includes a CPU 201, a main memory 202, a storage device 203, an input device 204, a display device 205, and an external I/F 206. The components included in the image processing apparatus 102 as the hardware configuration are connected via a bus 207 so as to be capable of communicating with one another.

The CPU 201 is an arithmetic processing device that integrally controls the image processing apparatus 102. The CPU 201 executes various programs stored in the storage device 203 or the like to perform diverse types of processing. The main memory 202 temporarily stores data, parameters, and the like to be used in the various types of processing and is used as a working area for the CPU 201. The storage device 203 is a mass storage device that stores the various programs, various types of data necessary to display the GUI, and the like. The storage device 203 is constituted by, for example, a hard disk drive or a nonvolatile memory such as a silicon disk drive. Note that the processes of steps illustrated in a flowchart described later are implemented in such a manner that a program code stored in the storage device 203 or the like is loaded onto the main memory 202 and executed by the CPU 201.

The input device 204 is constituted by a keyboard, a mouse, an electronic stylus, a touch-sensitive panel, or the like and accepts an operational input from the user. The display device 205 is constituted by a liquid crystal panel or the like and displays the GUI or the like. The external I/F 206 is an interface for communication with external devices such as the image capturing devices 101. For example, the image processing apparatus 102 and the image capturing devices 101 are connected via the external I/F 206 and a local area network (LAN) 208 and exchanges the captured image data, control signal data, and the like via the external I/F 206 and the LAN 208. The LAN 208 is not limited to a local area network and may be constituted by Serial Digital Interface (SDI), High-Definition Multimedia Interface® (HDMI®), or the like.

The image capturing devices 101 start and stop the image capturing, change the settings of image capturing conditions pertaining to their shutter speeds, diaphragms, or the like, and output the captured image data obtained through the image capturing, based on control signals output from the image processing apparatus 102. Note that the image processing apparatus 102 may include various component elements in addition to the above-described hardware configuration. The description of the various component elements, which are not the main point of the present disclosure, will be omitted.

On the assumption that the three-dimensional field is estimated through training a learning model that is modeled after the three-dimensional field in the image capturing space 106 (hereinafter, will be referred to as “three-dimensional field model”), a method for training the three-dimensional field model will be described. The present embodiment will be described on the assumption that, as an example, the three-dimensional field model is an NeRF constituted by a multilayer perceptron, and that the three-dimensional field is represented by radiance fields. However, the configuration of the three-dimensional field model and the three-dimensional field are not limited to this.

The method of representing the three-dimensional field differs according to content to be learned. Specifically, for example, the three-dimensional field model may be configured by means of InstantNGP, which is a fast method similar to NeRF. The three-dimensional field model is not limited to one configured by a multilayer perceptron. The three-dimensional field model may be configured by means of Plenoxels, Tensorial Radiance Fields (TensoRF), or the like, which explicitly represents a three-dimensional field. The three-dimensional field model may be configured by a NeuS, which uses Signed Distance Field (SDF) for the representation of a three-dimensional field, thus yielding an improved accuracy of the estimation of its shape.

The three-dimensional field model may also be configured by one of various methods, such as a three-dimensional field model configured by, for example, 3D Gaussian Splatting, which represents a three-dimensional field with a set of points with spatial extent.

### <Method for Estimating Three-Dimensional Field>

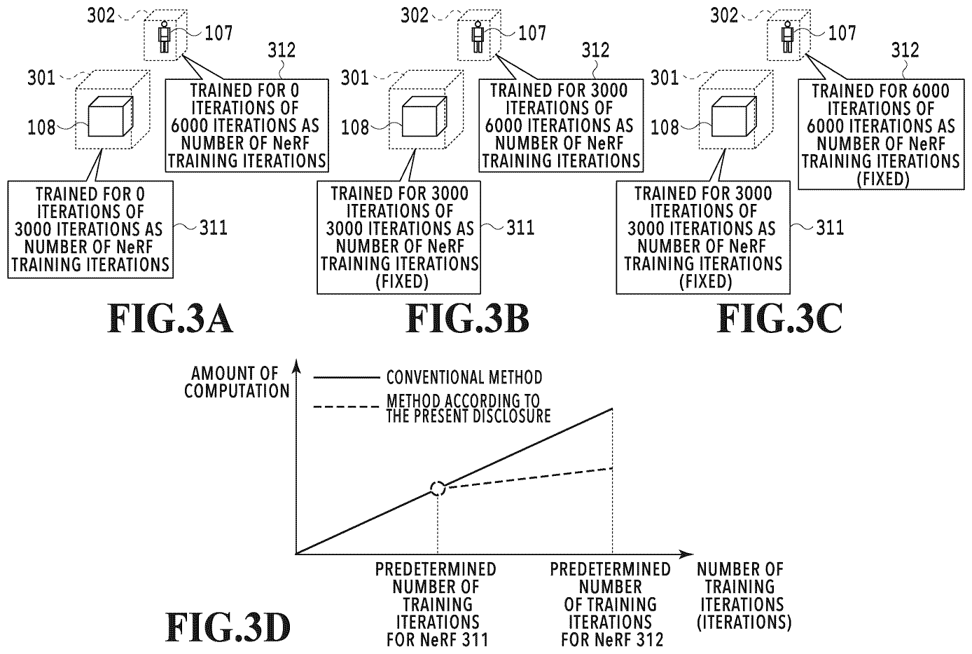

FIG. 3A to FIG. 3D are diagrams and a graph for describing the outline of a method for estimating the three-dimensional field in the image processing apparatus 102 according to Embodiment 1. Specifically, FIG. 3A illustrates learning target spaces 301 and 302, which correspond to the objects 107 and 108 or the objects 108 and 107, respectively, and NeRFs 311 and 312, which are assigned to the learning target spaces 301 and 302 or the learning target spaces 302 and 301, respectively. First, the image processing apparatus 102 sets the learning target spaces 301 and 302 corresponding to the objects 107 and 108 or the objects 108 and 107, respectively. For example, the image processing apparatus 102 obtains the sets of coordinates of the positions of the objects 107 and 108 in a three-dimensional space where the objects 107 and 108 are present. The image processing apparatus 102 then sets the learning target spaces 301 and 302 such that the learning target spaces 301 and 302 contain the regions of the objects 107 and 108 or the objects 108 and 107, respectively. The image processing apparatus 102 then assigns the NeRF 311 to the learning target space 301 and assigns the NeRF 312 to the learning target space 302. The image processing apparatus 102 then sets the numbers of training iterations of NeRFs 311 and 312. The numbers of training iterations are determined based on the types, importance, or the like of the objects included in the learning target spaces.

The following will be described on the assumption that, as an example, the object 108 present in the learning target space 301 is a stationary object, and the object 107 present in the learning target space 302 is a moving object such as a natural person. The following will be described on the assumption that the object 108 is an object that has a lower importance (hereinafter, will be referred to as “unimportant object”) than the object 107. The following will be described on the assumption that the object 107 is, in contrast, as an object that has a higher importance (hereinafter, will be referred to as “important object”) than the object 108.

Additionally, the following will be described on the assumption that the number of training iterations for the NeRF 311 assigned to the learning target space 301, in which the object 108 being the unimportant object is present, is set to 3000 iterations. The following will be described on the assumption that the number of training iterations for the NeRF 312 assigned to the learning target space 302, in which the object 107 being the important object is present, is set to 6000 iterations, which is greater than the number of training iterations for the NeRF 311.

Next, the image processing apparatus 102 first performs the training of the NeRFs 311 and 312 until the number of training iterations set for the NeRF 311 (3000 iterations) is reached. The image processing apparatus 102 thereafter performs the remaining iterations of the training on the NeRF 312 until the number of training iterations set for the NeRF 312 (6000 iterations) is reached, with the parameters of the NeRF 311, of which the training has been completed for the predetermined number of training iterations, being fixed. After the training for the numbers of training iterations set for all the NeRFs is completed, the image processing apparatus 102 finishes the training of the NeRFs and causes the storage 104, the storage device 203, or the like to store the sets of parameters of the trained NeRFs. The sets of the parameters of the trained NeRFs are used to generate the virtual viewpoint image.

FIG. 3B illustrates the state in which the training has been performed on the NeRFs 311 and 312 for the number of training iterations that is set for the NeRF 311 (3000 iterations), and FIG. 3C illustrates the state in which the training has been performed on the NeRF 312 for the number of training iterations that is set for the NeRF 312 (6000 iterations). FIG. 3D illustrates an example of the relation between the numbers of training iterations and the amount of computation needed for the training until the training has been performed for the number of training iterations that is set for the NeRF 312 (6000 iterations). Note that the conventional method shown in FIG. 3D is a method for performing training for 6000 iterations on each of the NeRF 311 and the NeRF 312, as in the DeRF described in Non-Patent Literature 2. As described above, after the training for the number of training iterations set for the NeRF 311 (3000 iterations) is completed, the image processing apparatus 102 stops updating the parameters of the NeRF 311 and fixes the parameters. By fixing, in this manner, the parameters of an NeRF of which the training for the number of training iterations set for the NeRF (hereinafter, will be referred to as “predetermined number of training iterations”) has been completed, the total amount of computation needed to complete the training of all NeRFs may be reduced.

Specifically, in the conventional method, the training of the NeRF 311 continues in the training of the NeRF 312 even after the training of the NeRF 311 assigned to the learning target space 301 has been completed. Accordingly, the amount of computation needed to perform one iteration of the training is not changed even after the training of the NeRF 311 assigned to the learning target space 301 has been completed. As a result, the amount of computation needed for the training increases in a linear manner (a “substantially linear manner” is also included) until the training of NeRFs assigned to all learning target spaces has been completed, as illustrated in FIG. 3D. In contrast, in the technique according to the present disclosure, the training of the NeRF 311 assigned to the learning target space 301 is not performed after the training of the NeRF 311 has been completed. Accordingly, the amount of computation needed to perform one iteration of the training decreases after the training of the NeRF 311 assigned to the learning target space 301 has been completed. As a result, the technique according to the present disclosure makes it possible to lower the total amount of computation needed to complete the training of NeRFs assigned to all learning target spaces compared with the conventional method, as illustrated in FIG. 3D.

### <Functional Configuration of Image Processing Apparatus>

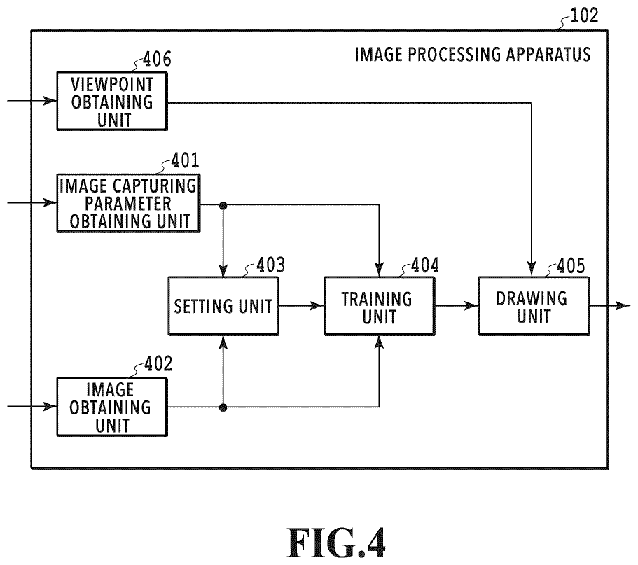

FIG. 4 is a block diagram illustrating an example of the functional configuration of the image processing apparatus 102 according to Embodiment 1. The image processing apparatus 102 includes an image capturing parameter obtaining unit 401, an image obtaining unit 402, a setting unit 403, a training unit 404, a viewpoint obtaining unit 406, and a drawing unit 405. The components included in the image processing apparatus 102 as the functional configuration are implemented by the CPU 201 executing a program stored in the storage device 203 or the like, using the main memory 202 as the working area. Note that all of the processes described below need not necessarily be implemented by the CPU 201 executing the program. The image processing apparatus 102 may be configured such that some or all of the processes are executed by one or more processing circuits other than the CPU 201. The following will be described on the assumption that, in the present embodiment, the image processing apparatus 102 estimates radiance fields corresponding to a three-dimensional space that is a target of the estimation of the three-dimensional field including the objects 107 and 108 (hereinafter, will be simply called “target three-dimensional space”).

The image obtaining unit 402 obtains data on multi-viewpoint images that are obtained through the synchronous image capturing by the image capturing devices 101. The image capturing parameter obtaining unit 401 obtains image capturing parameters of the image capturing devices 101 for capturing the captured images constituting the multi-viewpoint images. The multi-viewpoint images obtained by the image obtaining unit 402 and the image capturing parameters obtained by the image capturing parameter obtaining unit 401 are used to train an NeRF, which is an example of the three-dimensional field model.

The image capturing parameters include extrinsic parameters, intrinsic parameters, and distortion parameters. The extrinsic parameters are parameters that represent the position and orientation of each image capturing device. The intrinsic parameters are parameters that represent the coordinates of the center of a captured image obtained by the image capturing by the image capturing device and the focal length of a lens of the image capturing device. The distortion parameters are parameters that indicate the distortion of the lens. The image capturing parameters of each image capturing device 101 may be calculated from the result of camera calibration that is performed beforehand. The following will be described on the assumption that image capturing parameters of each image capturing device 101 are stored in the storage device 203 in advance, and the image capturing parameter obtaining unit 401 reads out the image capturing parameters of each image capturing device 101 by reading the image capturing parameters from the storage device 203. Note that the image capturing parameter obtaining unit 401 may calculate and obtain the image capturing parameters of each image capturing device 101 by performing camera calibration using the multi-viewpoint images obtained by the image obtaining unit 402.

The setting unit 403 determines, as decomposed spaces, spaces including the objects 107 and 108 from the target three-dimensional space, based on the multi-viewpoint images obtained by the image obtaining unit 402 and the image capturing parameters obtained by the image capturing parameter obtaining unit 401. The setting unit 403 also takes a plurality of the specified decomposed spaces as the learning target spaces 301 and 302 or the learning target spaces 302 and 301 and assigns the NeRF 311 and 312 to the learning target spaces. The setting unit 403 further specifies the importance, the complexities of the object shapes, or the like of the objects 107 and 108 in a scene and sets the numbers of training iterations for the NeRFs 311 and 312 based on the specified importance, complexities, or the like.

The training unit 404 performs the training of the NeRFs 311 and 312, which are assigned to the learning target spaces 301 and 302 by the setting unit 403, based on the multi-viewpoint images obtained by the image obtaining unit 402 and the image capturing parameters obtained by the image capturing parameter obtaining unit 401. Through the training, the radiance fields corresponding to the decomposed spaces including the objects 107 and 108, that is, the learning target spaces 301 and 302, are estimated.

Specifically, the training unit 404 refers to the number of training iterations of each of the NeRFs 311 and 312 assigned by the setting unit 403 and keeps a feature indicated by the values of the parameters of the NeRF 311 of which the training has been completed so that the feature will not be updated in the subsequent training. In addition, to the learning target space 301 that has been trained, the training unit 404 assigns the kept feature of the NeRF 311, of which the training has been completed, and does not train the NeRF 311 in the subsequent training. Meanwhile, in the subsequent training, the training unit 404 continues the training of the NeRF 312, of which the training has not been completed, while utilizing the kept feature of the NeRF 311, of which the training has been completed. After the training of all the NeRFs 311 and 312 assigned to the learning target spaces 301 and 302 is completed, the training unit 404 outputs the parameters of the trained NeRFs 311 and 312 to the storage 104 or the like to cause the storage 104 or the like to store the parameters.

The viewpoint obtaining unit 406 obtains virtual viewpoint information including information indicating the position and direction of each of the virtual viewpoints. The virtual viewpoint information may be, for example, a virtual camera path that is constituted by information that indicates the position and direction of a virtual viewpoint in a time-series manner. The drawing unit 405 generates an image corresponding to an appearance from the virtual viewpoint (a virtual viewpoint image) by performing a drawing process based on the trained NeRFs 311 and 312 obtained as the result of the training by the training unit 404 and the virtual viewpoint information obtained by the viewpoint obtaining unit 406. The virtual viewpoint image generated by the drawing unit 405 is output to the display 105, the display device 205, or the like to be displayed.

### <Operation of Image Processing Apparatus>

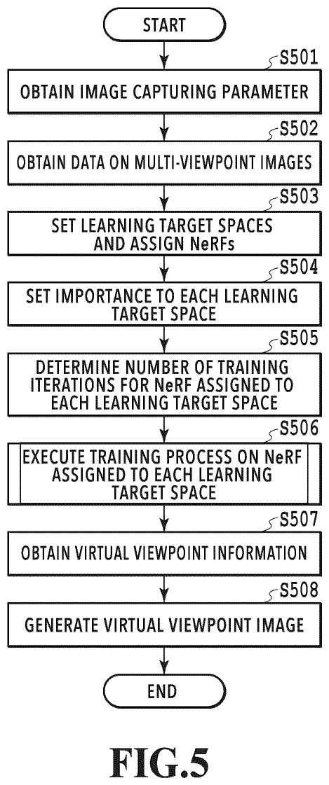

FIG. 5 is a flowchart illustrating an example of a processing flow of the image processing apparatus 102 according to Embodiment 1. With reference to the block diagram illustrated in FIG. 4 and the flowchart illustrated in FIG. 5, the operation of the image processing apparatus 102 will be described in detail. In the following description, the symbol “S” means a processing step. A series of processing steps in the image processing apparatus 102 to be described below is implemented by the CPU 201 reading out a given program from the storage device 203, loading the program onto the main memory 202, and executing the program.

First, in S501, the image capturing parameter obtaining unit 401 obtains the image capturing parameters of each image capturing device 101. The following will be described on the assumption that the image capturing parameters of each image capturing device 101 are not changed with time during the operation of the image processing apparatus 102. Note that the process of obtaining the image capturing parameters in S501 may be executed at any timing before the process of setting learning target spaces in S503 described later.

Next, in S502, the image obtaining unit 402 obtains data on multi-viewpoint images. Specifically, for example, the image obtaining unit 402 first transmits an image capturing instruction to the image capturing devices 101 via the external I/F 206 and the LAN 208, during a target period of the virtual viewpoint image to be generated. Receiving the image capturing instruction from the image processing apparatus 102, the image capturing devices 101 perform image capturing, and captured image data obtained through the image capturing is transmitted to the image processing apparatus 102 via the LAN 208 and the external I/F 206. The image obtaining unit 402 obtains the captured image data transmitted from the image capturing devices 101. The captured image data that correspond to the image capturing devices 101 and are obtained by the image obtaining unit 402 is stored in the main memory 202 or the like.

Next, in S503, the setting unit 403 sets learning target spaces for the object based on the image capturing parameters obtained in S501 and the multi-viewpoint images obtained in S502 and assigns new NeRFs to the learning target spaces. Specifically, the setting unit 403 first sets three-dimensional spaces including the objects 107 and 108 as the learning target spaces for NeRFs. The setting unit 403 then assigns, as the new NeRFs, untrained NeRFs to the set learning target spaces.

More specifically, for example, the setting unit 403 first specifies, for each of the objects, a three-dimensional space including the object by estimating the three-dimensional shape of the object based on image capturing parameters and captured images corresponding to the image capturing devices 101. For example, in a case where the captured images are moving images, the setting unit 403 specifies the three-dimensional spaces including the objects based on the image capturing parameters and reference frames of the captured images being the moving images. For example, the setting unit 403 estimates the three-dimensional shapes of the objects based on the image capturing parameters and the reference frames and sets, for each of the estimated three-dimensional shapes of the objects, the smallest rectangular cuboid that encloses the three-dimensional shape, as a learning target space. In this case, the size of the rectangular cuboid may be set to be larger than the object by a margin that is set relative to the size of the object. Then, regarding the three-dimensional spaces that contain the three-dimensional spaces specified for the objects as the learning target spaces, the setting unit 403 assigns the new NeRFs to the learning target spaces.

An example of the method for estimating the three-dimensional shapes of the objects is a visual hull (VH) method. In the VH method, regions including the representations of the objects are extracted as silhouette regions from the captured images constituting the multi-viewpoint images, and the three-dimensional shapes of the objects are obtained from the extracted silhouette regions and the image capturing parameters for capturing the captured images. Methods for extracting the silhouette regions of the objects in the captured images include a background subtraction method of obtaining subtractions between the captured images and a background image that is obtained beforehand, and a method for performing a segmentation process on the captured images. The setting unit 403 projects the silhouette region of each object in each captured image into a three-dimensional space based on image capturing parameters corresponding to the captured image and obtains the product set of the projections, as the three-dimensional shape of the object.

Specifically, the setting unit 403 first defines a three-dimensional space that is filled with voxels having a given size. Then, for each of all the voxels in the three-dimensional space, the setting unit 403 projects, using image capturing parameters corresponding to each image capturing device 101, the voxel onto each of the two-dimensional captured images constituting the multi-viewpoint images, from the three-dimensional space. The setting unit 403 judges whether each projected voxel overlaps the silhouette region of an object in each captured image. The setting unit 403 then determines a voxel that is judged to overlap captured images the number of which is greater than or equal to a given threshold value, as a voxel that constitutes a part of the three-dimensional shape of the object. For example, the setting unit 403 gives “0,” which indicates an OFF voxel, to the flags of all the voxels, as an initial value. The setting unit 403 changes the value of the flag of a voxel that is determined to be a voxel constituting a part of the three-dimensional shape of an object to “1,” which indicates an ON voxel. A set of voxels of which the value of the flag is set to “1” (ON voxels) is regarded as a voxel group that constitutes the three-dimensional shape of the object.

The present embodiment will be described on the assumption that the three-dimensional shape of an object is estimated using the VH method. However, the method for estimating the three-dimensional shape of an object is not necessarily limited to the VH method. For example, the three-dimensional shape of an object may be estimated based on a small number of captured images obtained through image capturing by one or more image capturing devices 101, using a trained model that is obtained as the result of a training through deep learning. Alternatively, the three-dimensional shape of an object may be estimated by specifying, in the form of a point cloud, the positions of the surfaces of the object in a three-dimensional space using a distance measuring device equipped with LiDAR or the like.

After S503, in S504, for each of the set learning target spaces, the importance of the learning target space is set. The importance of each learning target space may be set in accordance with the type of an object present in the learning target space, the appearance of the object from a virtual viewpoint, or the like. For example, in a case where the setting unit 403 sets the importance of the learning target spaces based on the types of the objects, the setting unit 403 may be set the importance of a learning target space to be high in a case where an object present in the learning target space is a natural person. In this case, for example, the setting unit 403 judges whether the object present in the learning target space is a natural person, using a human detector that receives a captured image and detects a natural person included in the captured image in the form of a representation. For example, for a higher likelihood output from the human detector, the setting unit 403 sets a higher importance to a learning target space corresponding to an object, considering the probability that the object is a natural person to be high. Here, the likelihood is an index that represents how well the object resembles a given target.

In a case where likelihoods corresponding to the objects 107 and 108 output from the human detector are “0.6” and “0.3,” respectively, the setting unit 403 sets the importance of learning target spaces corresponding to the objects 107 and 108 as follows, for example. Specifically, in this case, for example, the setting unit 403 sets the importance of the learning target space corresponding to the object 107 to “0.6” and sets the importance of the learning target space corresponding to the object 108 to “0.3.” The above-described method for setting the importance of learning target spaces based on likelihoods is merely an example and should not be construed as limiting.

In a case where, for example, the setting unit 403 sets the importance of the learning target spaces based on the appearance of the object from a virtual viewpoint, the setting unit 403 sets the importance of the learning target spaces as follows, for example. First, the setting unit 403 inversely projects the three-dimensional shapes of the objects 107 and 108 estimated in S503 onto an image plane of the virtual viewpoint image that may be generated. The plurality of objects are assumed to be consistent between the virtual viewpoint image and the captured images with regard to which object corresponds to one of the regions that are the three-dimensional shapes of the objects inversely projected onto the image plane.

For example, in a case where the sizes of the silhouettes of the objects 107 and 108 in the virtual viewpoint image are 600 pixels and 300 pixels, respectively, the setting unit 403 sets the importance of the learning target spaces corresponding to the objects 107 and 108 as follows, for example. Specifically, in this case, for example, the setting unit 403 sets the importance of the learning target space corresponding to the object 107 to “0.6” and sets the importance of the learning target space corresponding to the object 108 to “0.3.” The above-described method for setting the importance of learning target spaces based on the appearances of the objects from a virtual viewpoint is merely an example and should not be construed as limiting.

The setting method based on the type of an object present in each learning target space or the appearance of the object from a virtual viewpoint has been described above as an example of the method for setting the importance of the learning target spaces. However, the method for setting the importance of the learning target spaces is not limited to this. For example, the importance of the learning target spaces may be set based on temporary importance of the objects that are set in advance by a user. For example, the user sets in advance temporary importance as the importance of the objects 107 and 108. The temporary importance of each object may be set to be any importance based on the type of the object or the importance of the object recognized by the user, such as an importance based on interest or concern.

For example, in a case where the temporary importance set to the objects 107 and 108 are “0.6” and “0.3,” respectively, the setting unit 403 sets the importance of the learning target spaces corresponding to the objects 107 and 108 as follows. Specifically, in this case, for example, the setting unit 403 sets the importance of the learning target space corresponding to the object 107 to “0.6” and sets the importance of the learning target space corresponding to the object 108 to “0.3.” The above-described method for setting the importance of learning target spaces based on the temporary importance of the objects is merely an example and should not be construed as limiting.

The setting unit 403 may set the importance of the learning target spaces using the methods for setting the importance of the learning target spaces, which have been described above as examples, in combination. For example, the setting unit 403 sets true importance of the learning target spaces by adding, to the importance determined based on the sizes of the regions of the objects in the virtual viewpoint image, given weights based on the temporary importance that are set to the object in advance. Specifically, assume that, for example, the set values of the importance of the learning target spaces based on the types of the objects are “0.6” for the object 107 and “0.3” for the object 108. In addition, assume that the set values of the importances of the learning target spaces based on the appearances of the objects from a virtual viewpoint are “0.6” for the object 107 and the “0.3” for the object 108. In this case, for example, the setting unit 403 multiplies the corresponding importance together, and sets the importance of the learning target space corresponding to the object 107 to “0.36” and sets the importance of the learning target space corresponding to the object 108 to “0.09.” The method for setting the importance of the learning target spaces using the plurality of types of importance in combination is not limited to this.

Alternatively, for example, the setting unit 403 may set the importance of the learning target spaces corresponding to the objects based on the complexities of the three-dimensional shapes of the objects that are estimated in S503. The complexities of the three-dimensional shapes of the objects may be calculated by, for example, obtaining the magnitude of the variance of the distribution of normals. The following will be described on the assumption that the setting unit 403 sets the importance of the learning target spaces corresponding to the objects based on the types of the objects and the sizes of the regions of the objects in the virtual viewpoint image, as an example.

After S504, in S505, the setting unit 403 sets the numbers of training iterations for the new NeRFs that are assigned to the learning target spaces in S503 based on the importance of the learning target spaces that are set in S504. For example, the numbers of training iterations for the learning target spaces are set in accordance with the ratios of the importance of the learning target spaces that are set in S504. For example, as described above, in a case where the importance of the learning target spaces are set in accordance with the types of the objects, the ratio between the number of training iterations for the NeRF 311 assigned to the learning target space 301 and the number of training iterations for the NeRF 312 assigned to the learning target space 302 is 0.3:0.6=1:2. Assuming that the number of training iterations for an NeRF used as a reference is set in advance, the numbers of training iterations for the learning target spaces are set in accordance with the ratio. For example, assuming that the number of training iterations of the NeRF for a learning target space having the smallest ratio in number of training iterations is used as a reference, and letting the number of training iterations be 3000 iterations, the number of training iterations for the NeRF 311 is 3000 iterations, and the number of training iterations for the NeRF 312 is 6000 iterations.

Next, in S506, the training unit 404 executes a training process on the NeRFs that are assigned to the learning target spaces in S503. Specifically, the training unit 404 performs the training on the NeRFs that are assigned to the learning target spaces in S503, for their predetermined numbers of iterations, in accordance with the numbers of training iterations that are set in S505. The training process of S506 will be described in detail later. Next, in S507, the viewpoint obtaining unit 406 obtains the virtual viewpoint information. Next, in S508, the drawing unit 405 generates the virtual viewpoint image. Specifically, the drawing unit 405 generates the virtual viewpoint image based on the feature of the trained NeRFs obtained as the result of the training process of S506, that is, estimated radiance fields, and the virtual viewpoint information obtained in S507. As the method for generating the virtual viewpoint image, the method of volume rendering may be used. The method of volume rendering will be described in detail later. After S508, the image processing apparatus 102 finishes the processes in the flowchart illustrated in FIG. 5.

### <Training Process>

Prior to the description of the training process in the training unit 404 according to the present embodiment, a typical method for training an NeRF will be described. In response to an input of a given position (x, y, z) in a learning target space and a viewing direction (θ, φ) to the position, an NeRF estimates a color value c and a density σ corresponding to the position. Specifically, in an NeRF, a ray corresponding to the direction from an image capturing position to each pixel in a captured image is first set. Then, a plurality of sampling points are set on the set ray. Then, the color values c and densities σ at the set sampling points are estimated. Then, by integrating the color value c and densities σ estimated at sampling points on an identical ray are integrated from the image capturing position, the values of pixels (pixel values) corresponding to the rays are determined, and thus an image corresponding to the captured image is generated. The generation of an image in this manner is generally called volume rendering. Then, weight parameters of a neural network constituting the NeRF are updated in such a manner as to decrease the difference between the image generated through the volume rendering and the captured image as ground truth data corresponding to the generated image.

In the present embodiment, an NeRF is assigned to each of learning target spaces corresponding to the object. Accordingly, in a case where two or more objects are present in the target three-dimensional space, two or more learning target spaces are set in the target three-dimensional space. Thus, two or more NeRFs are assigned in the target three-dimensional space. In a case where two or more NeRFs are assigned in the target three-dimensional space, the pixel value of a certain ray that passes through a plurality of learning target spaces is determined by executing the above-described integration process on the plurality of learning target spaces through which the ray passes.

For example, in a case where the ray corresponding to a certain pixel passes through the learning target space 301 and the learning target space 302 in this order, a plurality of sampling points are set in each of the learning target spaces 301 and 302 by the NeRFs assigned to the learning target spaces 301 and 302. Then, the color value and density at each sampling point in the learning target spaces 301 and 302 are estimated by the NeRFs assigned to the learning target spaces 301 and 302. Then, the volume rendering is performed in such a manner that the color values and densities at the sampling points estimated in the learning target spaces 301 and 302 are integrated in order, thus generating an image. The method for training two or more NeRFs assigned in the target three-dimensional space and the method of the volume rendering in a case where two or more NeRFs are assigned in the target three-dimensional space are disclosed in Non Patent Literature 2.

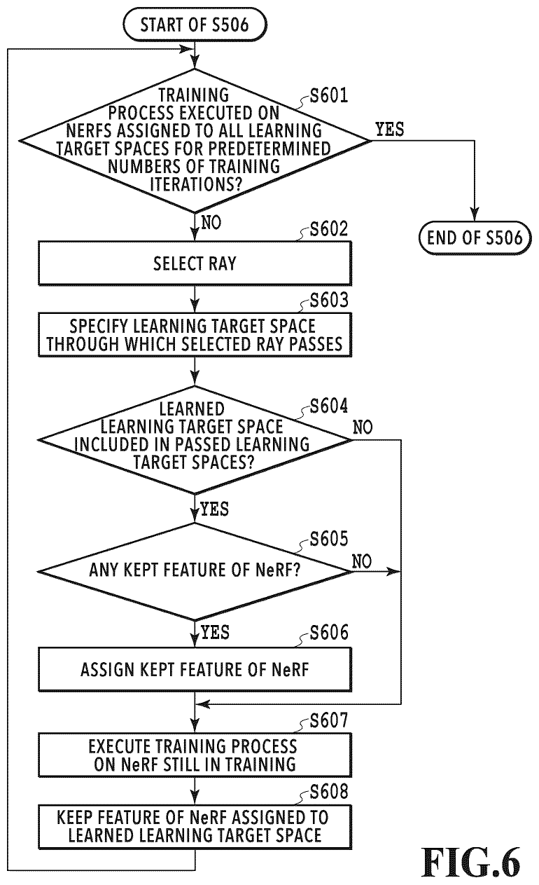

FIG. 6 is a flowchart illustrating an example of the flow of the training process in the training unit 404 according to Embodiment 1, that is, a detailed flow of the process of S506 illustrated in FIG. 5. With reference to the flowchart illustrated in FIG. 6, the training process in the training unit 404, that is, the method for estimating radiance fields according to the present embodiment will be described. The process of flowchart illustrated in FIG. 6 is executed after the process of S505 illustrated in FIG. 5.

After S505, first, in S601, the training unit 404 judges, for each NeRF assigned to all the learning target spaces, whether the training process has been executed for the number of training iterations (the predetermined number of training iterations) that is set for the NeRF in S505. If the training unit 404 judges that the training process has been executed in S601 on the NeRFs assigned to all the learning target spaces for their predetermined numbers of training iterations, the training unit 404 finishes the processes in the flowchart illustrated in FIG. 6, that is, the process of S506 illustrated in FIG. 5. If the training unit 404 judges that the training process has not been executed on an NeRF assigned to at least one of the learning target spaces for its predetermined number of training iterations, the training unit 404 executes the process of S602. In S602, the training unit 404 selects an arbitrary ray from among a group of rays to be learned. Hereinafter, the ray selected in S602 will be referred to as “selected ray.” Here, the group of rays to be learned refers to a plurality of rays that are emitted from an image capturing position in directions toward the pixels in a captured image.

After S602, in S603, the training unit 404 specifies one or more learning target spaces through which the ray selected in S602 (the selected ray) passes, from among the plurality of learning target spaces that are set in S503. In a case where the number of learning target spaces specified as the one or more learning target spaces through which the selected ray passes (hereinafter, will be referred to as “passed learning target spaces”) is two or more, the training unit 404 also specifies, in S603, the order in which the selected ray passes the passed learning target spaces. The one or more passed learning target spaces specified in S603 and information about the order of passing through the one or more passed learning target spaces are stored in the main memory 202 or the like. In a case where the selected ray passes through the learning target spaces, the number of training iterations that has been done on the NeRF assigned to each of the one or more passed learning target spaces (hereinafter, will be referred to as “number of training iterations done”) is incremented, and information about the number is stored in the main memory 202 or the like. In a case where the number of training iterations done reaches a predetermined number of training iterations, the training unit 404 does not increment the number of training iterations done but treats, in the subsequent processes, a NeRF of which the number of training iterations done has reached the predetermined number of training iterations as a trained NeRF. Hereinafter, a learning target space assigned an NeRF of which the number of training iterations done has reached its predetermined number of training iterations will be referred to as “learned learning target space.”

After S603, in S604, the training unit 404 judges whether one or more learned learning target spaces are included in the one or more passed learning target spaces that are specified in S603. If it is judged in S604 that one or more learned learning target space are included in the one or more passed learning target spaces, the training unit 404 executes the process of S605; otherwise, the training unit 404 executes the process of S607 described later. In S605, the training unit 404 judges, for each of the one or more learned learning target spaces included in the one or more passed learning target spaces, whether there is a kept feature of an NeRF. The feature of an NeRF will be described specifically later. If it is judged in S605 that there is a kept feature of an NeRF for a learned learning target space, the training unit 404 executes the process of S606; otherwise, the training unit 404 executes the process of S607 described later. In S606, the training unit 404 assigns the kept feature of an NeRF to one or more passed learning target spaces that have been learned. After the process of S606, the training unit 404 executes the process of S607.

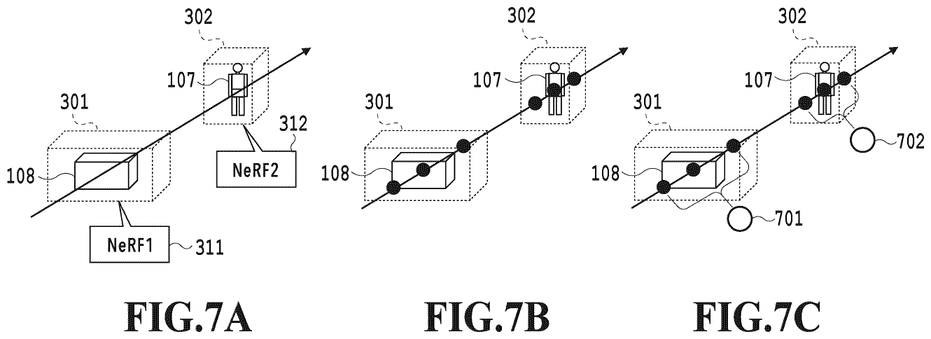

FIG. 7A to FIG. 7C are diagrams for describing examples of the features of NeRFs 311 and 312 according to Embodiment 1. Specifically, FIG. 7A illustrates the NeRFs 312 and 311 or the NeRFs 311 and 312 assigned to the learning target spaces 301 and 302, respectively. FIG. 7B illustrates an example of sampling points set in the learning target spaces 301 and 302, and FIG. 7C illustrates features 701 and 702 of the NeRFs 311 and 312 or the NeRF 312 and 311, respectively. Note that, the arrow penetrating the learning target spaces 301 and 302 in each of FIG. 7A to FIG. 7C shows an example of a ray that corresponds to a given pixel in a captured image obtained through image capturing performed from an image capturing position k.

Examples of the feature of an NeRF include the weight parameters of each of the NeRFs 311 and 312. As illustrated in FIG. 7B as an example, the feature of an NeRF may include a color value c and a density σ that are estimated as the result of training at each of the sampling points that are set in the learning target spaces 301 and 302. In this case, the features of the NeRFs 311 and 312 each of which is represented with color values c and densities σ may be represented as c (k, r, w, h) and σ (k, r, w, h), respectively. Here, k denotes an image pickup position, (w, h) denotes a pixel position in a captured image obtained through image capturing from the image capturing position k, and r denotes an identifier such as a number with which the NeRFs 311 and 312 can be uniquely identified. Causing such features in the storage 104 or the like makes it possible to train an NeRF assigned to a learning target space still in training while utilizing the feature of an NeRF assigned to a learned learning target space.

As illustrated in FIG. 7C as an example, the features 701 and 702 of the NeRFs may be each a value C obtained by integrating, from an image capturing position, color values c and densities σ estimated at sampling points that are set on an identical ray and in an identical learning target space. The values C of the features 701 and 702 each represented with the integrated value of color values and the integrated value of densities may be calculated using, for example, Equations (1) and (2) shown below.

$$C ( k , r , w , h ) = {\sum }_{i = 1}^{N} {T}_{i} ( k , r , w , h ) ( 1 - exp ( - {σ}_{i} ( k , r , w , h ) {δ}_{i} ) ) \qquad Equation ( 1 )$$

$${T}_{i} ( k , r , w , h ) = exp ( - {\sum }_{j = 1}^{i - 1} {σ}_{i} ( k , r , w , h ) {δ}_{i} ) \qquad Equation ( 2 )$$

Here, Tᵢ denotes an accumulated transmittance at each sampling point. As with the above description, k denotes an image pickup position, (w, h) denotes a pixel position in a captured image, and r denotes an identifier of an NeRF. N denotes the total number of sampling points, and δᵢ denotes the distance from a sampling point i, which is the ith sampling point, to a sampling point i+1, which is the next (i+1)th sampling point. The integrated value of densities in the feature of an NeRF may be represented with an integrated value W of weights w into which the densities are converted. The integrated value W of the weights may be calculated using, for example, Equations (3) and (4) shown below.

$$W ( k , r , w , h ) = {\sum }_{i = 1}^{N} {w}_{i} ( k , r , w , h ) \qquad Equation ( 3 )$$

$${w}_{i} ( k , r , w , h ) = {T}_{i} ( k , r , w , h ) ) ( 1 - exp ( - {σ}_{i} ( k , r , w , h ) {δ}_{i} ) \qquad Equation ( 4 )$$

The feature of an NeRF may include various features such as a feature including, in addition to the color values c and densities σ estimated at the sampling points, values obtained by integrating color values and densities of sampling points that are set on an identical ray and in an identical learning target space. In S607, the training unit 404 executes the training process on one or more NeRFs assigned to one or more learning target spaces still in training. In the process of S607, the training of the one or more learned learning target spaces is performed utilizing the kept feature of an NeRF. Thus, the weight parameters of the NeRF are not updated.

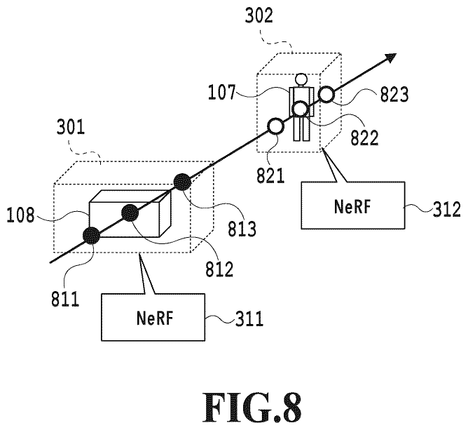

FIG. 8 is a diagram for describing an example of the training process in the training unit 404 according to Embodiment 1, being a diagram for describing an example of the process of S607 illustrated in the flowchart in FIG. 6. FIG. 8 illustrates the NeRF 311 that has been trained and assigned to the learning target space 301 that has been trained, and the NeRF 312 still in training and assigned to the learning target space 302 still in training. Note that the arrow penetrating the learning target spaces 301 and 302 in FIG. 8 shows an example of a ray that corresponds to a given pixel in a captured image obtained through image capturing performed from an image capturing position k. In FIG. 8, solid black circles show an example of sampling points 811 to 813 at which color values and densities have been learned, and solid white circles show an example of sampling points 821 to 823 at which color values and densities are being learned.

In the training process of S607, first, the color values and densities at the sampling points 811 to 813 in the learning target space 301 are calculated using the trained NeRF 311 that is obtained as the result of the training based on a reference frame. Then, the color values and densities at the sampling points 821 to 823 in the learning target space 302 are calculated using the NeRF 312 still in training. Then, the volume rendering is performed by integrating the color values and densities calculated at the sampling points 811 to 813 and 821 to 823. Thus, the value of a pixel (pixel value) corresponding to a ray that passes through the sampling points 811 to 813 and 821 to 823 is calculated. Finally, the weight parameters of the NeRF 312 are updated by feeding errors between the pixel values and the values of pixels in a captured image corresponding to the pixels back to the NeRF 312 while the weights of the trained NeRF 311 are kept. In the above manner, the training unit 404 performs, in the training process of S607, training utilizing the weight parameters of the trained NeRF 311 assigned to the learned learning target space 301.

Next, a case is described where color values and densities at learned sampling points are assigned as the feature of a trained NeRF. The color values and densities at the sampling points 821 to 823 in the learning target space 302 are calculated using the NeRF 312 that is being trained. Then, the volume rendering is performed by integrating the color values and densities at the sampling points 811 to 813 and 821 to 823. Thus, the value of a pixel (pixel value) corresponding to a ray that passes through the sampling points 811 to 813 and 821 to 823 is calculated. Finally, the weight parameters of the NeRF 312 are updated by feeding errors between the pixel values and the values of pixels in a captured image corresponding to the pixels back to the NeRF 312. In the above manner, the training unit 404 performs training utilizing color values and densities, which are the feature of the trained NeRF 311 assigned to the learned learning target space 301.

Next, a case is described where the integrated values of color values and densities at learned sampling points are assigned as the feature of a trained NeRF. First, the color values and densities at the sampling points 821 to 823 in the learning target space 302 are calculated using the NeRF 312 that is being trained. Then, with the integrated values of the learned color values and densities obtained as the result of the training based on the reference frame being assigned as the integrated values of the color values and densities at the sampling points 811 to 813, the color values and densities at the sampling points 821 to 823 are integrated. The volume rendering is thus performed, and the value of a pixel (pixel value) corresponding to a ray that passes through the sampling points 811 to 813 and 821 to 823 is calculated. Finally, the weight parameters of the NeRF 312 are updated by feeding errors between the pixel values and the values of pixels in a captured image corresponding to the pixels back to the NeRF 312. In the above manner, the training unit 404 performs training utilizing the integrated values of color values and densities, which are the feature of the trained NeRF 311 assigned to the learned learning target space 301.

The details of the training process may be changed in accordance with the positional relation between a learned learning target space and a learning target space still in training. For example, in a case where the learned learning target space is closer to an image capturing position than the learning target space still in training, training unit 404 may execute the following process. In this case, the training unit 404 first refers to a feature that indicates the integrated value of densities, out of features that are assigned to the learned learning target space and correspond to rays. In a case where the integrated value of learned densities corresponding to a certain ray is greater than or equal to a given threshold value, the training unit 404 may omit the training of an NeRF assigned the learning target space still in training. Here, the case where the integrated value of learned densities corresponding to a certain ray is greater than or equal to the given threshold value is, for example, a case where an object present in the learned learning target space on a path through which the ray passes is neither transparent nor translucent.

In contrast to this, in a case where, for example, the learning target space still in training is closer to an image capturing position than the learned learning target space, training unit 404 may execute the following process. In this case, the training unit 404 first calculates the integrated value of densities in the learning target space still in training that corresponds to each ray. In a case where the integrated value corresponding to a certain ray is greater than or equal to a given threshold value, the training unit 404 may perform the volume rendering using only the NeRF assigned the learning target space still in training. Here, the case where the integrated value corresponding to a certain ray is greater than or equal to the given threshold value is, for example, a case where an object present in the learning target space still in training on a path through which the ray passes is neither transparent nor translucent. Such a process is performed because the learned learning target space is occluded by the learning target space still in training in a case where the learned learning target space is viewed from the image capturing position in a direction in which the ray travels. The training unit 404 then updates the weight parameters of the NeRF 312 by feeding errors between the values of pixels calculated through the volume rendering and the values of pixels in a captured image corresponding to the pixels back to the NeRF 312.

On the other hand, in a case where the integrated value of the densities of the learning target space still in training corresponding to a certain ray is less than the threshold value, the training unit 404 may execute the following process. In this case, the training unit 404 first calculates the sum of the integrated value of the densities of the learning target space still in training and the integrated value of the densities of the learned learning target space. In a case where the sum is less than a given threshold value, the training unit 404 executes the following process. In this case, the training unit 404 first calculates the integrated values of the color values and densities of the learning target space still in training and calculates the sums of the integrated values and the integrated values of trained color values and densities assigned to the learned learning target space. The training unit 404 then updates the weight parameters of NeRF 312 by feeding errors between the values of the sums and pixel values of the captured image back to the NeRF.

In a case where the sum of the integrated value of the densities of the learning target space still in training and the integrated value of the densities of the learned learning target space is greater than or equal to the threshold value, the training unit 404 may execute the following process. In this case, the training unit 404 first calculates the integrated values of the color values and densities of the learning target space still in training. Concerning the integrated values, the training unit 404 then integrates the color values and densities at the learned sampling points in the learned learning target space in order from closest to the learning target space still in training until the integrated values of densities becomes greater than or equal to the above-described threshold value. The training unit 404 then updates the weight parameters of NeRF 312 by feeding errors between the pixel values obtained by the integration and pixel values of the captured image back to the NeRF.

After S607, in S608, the training unit 404 stores the feature of an NeRF assigned to the learning target space of which the number of training iterations done has reached its predetermined number of training iterations, that is, the learned learning target space, in the main memory 202 or the like to make the feature to be kept. Specifically, a space on which the training is to be newly completed in S601 and spaces of which the training has already been completed are specified. Accordingly, in S608, the above-mentioned feature of an NeRF is saved for the learning target space of which the trained is newly completed. Here, examples of the feature of an NeRF include the weight parameters of the NeRF itself, color values and densities at sampling points for each ray, and the like, as mentioned above. Note that the feature of an NeRF for a learning target space on which the training has already been completed does not need to be saved again. However, in a case where the feature of an NeRF is saved for each ray, there may be a case where no feature about some ray has not been saved even in a learned learning target space. In such a case, the feature about a ray used in the process of S607 may be newly saved.

After the process of S608, the training unit 404 returns to the process of S601 and repeatedly executes the processes in the flowchart illustrated in FIG. 6 until it is judged in S601 that the training process has been executed on the NeRFs assigned to all the learning target spaces for their predetermined numbers of training iterations.

In the present embodiment, an aspect in which the estimated three-dimensional shapes of objects are inversely projected onto an image plane, and the numbers of training iterations are set based on the sizes of the regions in the image plane that correspond to the objects has been described as an example. However, the method for setting the numbers of training iterations is not limited to this. For example, the numbers of training iterations may be set in accordance with the distances from each image capturing position to the estimated three-dimensional shapes of the objects. Specifically, for example, the setting unit 403 may regard an object present at the closest position to the position of a virtual viewpoint in a viewing direction at the virtual viewpoint as an object having a high importance, and may set a larger number of training iterations to a learning target space where the object is present. Alternatively, for example, the setting unit 403 may use the volumes of the estimated three-dimensional shapes of objects as an index for setting the numbers of training iterations, or may use the above-described distances from each image capturing position and the volumes of the three-dimensional shapes of the objects in combination as an index for setting the numbers of training iterations.

In the present embodiment, an aspect in which the number of training iterations is set for each learning target space has been described as an example. However, the number of training iterations may be set for each ray. Specifically, for example, the number of training iterations for a certain learning target space is set to a given number of iterations, such as three iterations, for each ray, and the training of the learning target space may be regarded as having been completed in a case where the training has been performed all rays for the given number of iterations. In this case, the training unit 404 may preferentially select a ray with a large remaining number of training iterations in S602.

### <Effects Produced by Image Processing Apparatus>

As described above, in the present embodiment, the image processing apparatus 102 is configured to set the number of training iterations for each learning target space and utilize the feature of one or more NeRFs assigned to one or more learned learning target spaces to train one or more learning target spaces still in training. Such an image processing apparatus 102 enables the reduction of the amount of computation needed to estimate a three-dimensional field.

### Embodiment 2

The image processing apparatus 102 according to Embodiment 1 is an image processing apparatus that sets the number of training iterations for each learning target space based on the importance of the learning target space and utilizes the result of training an NeRF of a learned learning target space for training a learning target space still in training. In Embodiment 2, an aspect in which the completion of training of each learning target space is judged based on the convergence degree of the training of the corresponding NeRF will be described. Note that the configuration of an image capturing system and the configuration of an image processing apparatus according to Embodiment 2 are the same as in Embodiment 1, and thus the same components will be hereinafter described using reference numerals given in FIG. 1, 2, or 4.

### <Operation of Image Processing Apparatus>

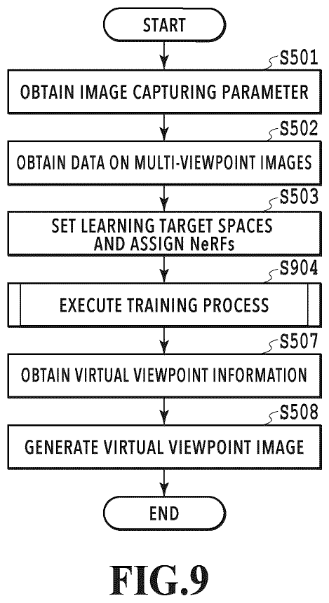

FIG. 9 is a flowchart illustrating an example of a processing flow of the image processing apparatus 102 according to Embodiment 2. The operation of the image processing apparatus 102 will be described in detail below with reference to the block diagram illustrated in FIG. 4 and the flowchart illustrated in FIG. 9. Note that, in the description of the flowchart illustrated in FIG. 9, a processing step that performs the same process as a processing step illustrated in FIG. 5 will be given the corresponding reference character illustrated in FIG. 5, and the description thereof will be omitted. A series of processing steps illustrated in the flowchart in FIG. 9 is implemented by the CPU 201 reading out a given program from the storage device 203, loading the program onto the main memory 202, and executing the program.

The image processing apparatus 102 first executes the processes from S501 to S503. After S503, in S904, the training unit 404 executes the training process while judging how far the training of an NeRF assigned to each of learning target spaces has converged. The process of S904 will be described in detail later. After S904, the image processing apparatus 102 executes the processes in S507 and S508 and, after S508, finishes the processes in the flowchart illustrated in FIG. 9.

### <Training Process>

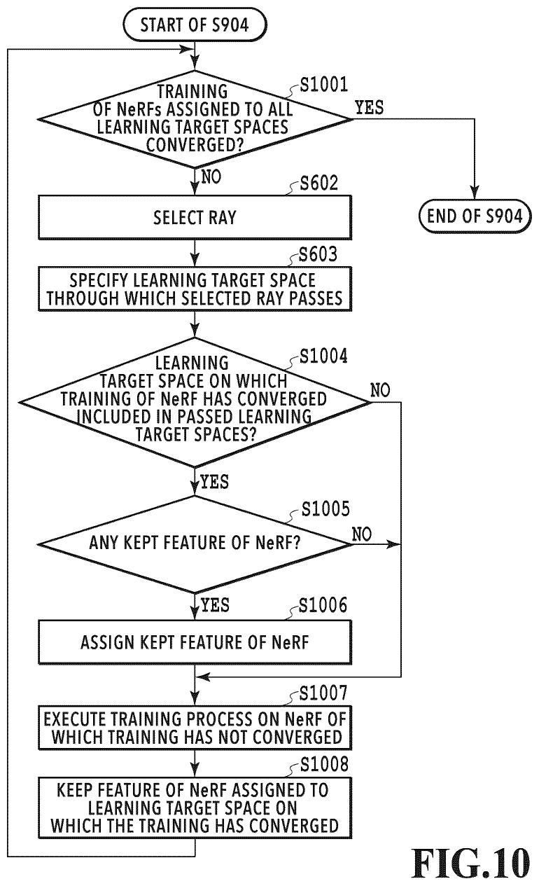

FIG. 10 is a flowchart illustrating an example of the flow of the training process in the training unit 404 according to Embodiment 2, that is, a detailed flow of the process of S904 illustrated in FIG. 9. With reference to the flowchart illustrated in FIG. 10, the training process in the training unit 404, that is, the method for estimating radiance fields according to the present embodiment will be described. Note that, in the description of the flowchart illustrated in FIG. 10, a processing step that performs the same process as a processing step illustrated in FIG. 6 will be given the corresponding reference character illustrated in FIG. 6, and the description thereof will be omitted. The process of flowchart illustrated in FIG. 10 is executed after the process of S503 illustrated in FIG. 9.

First, in S1001, the training unit 404 judges whether the training has converged, for each of NeRFs assigned to all the learning target spaces. If it is judged in S1001 that the training of the NeRFs assigned to all the learning target spaces has been converged, the training unit 404 finishes the processes in the flowchart illustrated in FIG. 10, that is, the process of S904 illustrated in FIG. 9. If the training unit 404 judges in S1001 that the training of an NeRF assigned to at least one of the learning target spaces has not converged, the training unit 404 executes the processes in S602 and S603. Note that the process of judging whether the NeRF assigned to each learning target space has converged is performed in S1007. Therefore, in the process of S1001 in the first repetition of the processes, it is judged that the training of none of the NeRFs assigned to all the learning target spaces has converged.

After the process of S603, in S1004, the training unit 404 judges whether any learning target space for which the training of an NeRF has converged is included in the one or more passed learning target spaces specified in S603. If it is judged in S1004 that a learning target space for which the training of an NeRF has converged is included in the one or more passed learning target spaces, the training unit 404 executes the process of S1005; otherwise, the training unit 404 executes the process of S1007 described later.

In S1005, the training unit 404 judges whether the kept feature of an NeRF is present in the learning target space for which the training of an NeRF has converged and that is included in the one or more passed learning target spaces. A specific description of the feature of an NeRF will be omitted because it is described above in Embodiment 1. If it is judged in S1005 that the kept feature of an NeRF is present in the learning target space for which the training of an NeRF has converged, the training unit 404 executes the process of S1006; otherwise, the training unit 404 executes the process of S1007. In S1006, the training unit 404 assigns the kept feature of an NeRF to the learning target space on which the training has converged. The method for assigning the feature of an NeRF is the same as the assignment method according to Embodiment 1, and the description thereof will be omitted. After the process of S1006, the training unit 404 executes the process of S1007.

In S1007, the training unit 404 executes the training process on one or more NeRFs assigned to one or more learning target spaces on which the training has not converged. In the process of S1007, the training of the one or more learning spaces on which the training has converged is performed utilizing the kept feature of an NeRF. Thus, the weight parameters of the NeRF are not updated. The description of a training method using the kept feature of an NeRF will be omitted because it is described above in Embodiment 1. After S1007, in S1008, the training unit 404 stores the feature of an NeRF assigned to the learning target space on which the training has converged in the main memory 202 or the like to make the feature to be kept. An example of a method for judging whether the training of the NeRF assigned to each learning target space has converged is a method based on the amount of reduction in loss in the training. For example, a loss Li, which is calculated in the training process for the ith iteration (i is an integer equal to or greater than one) may be calculated using, for example, Equation (5) shown below.

$${L}_{i} = ‖ {C}_{i} ( k , r , w , h ) - {C}^{′} ( k , r , w , h ) ‖ \qquad Equation ( 5 )$$

Here, Cᵢ(k, r, w, h) is a feature calculated through, for example, the volume rendering using Equation (1) in the training process for the ith iteration (i is an integer equal to or greater than one), and C′(k, r, w, h) is a corresponding pixel value of a captured image. The process of judging whether the training of an NeRF has converged may be performed by, for example, comparing the amount of reduction in the loss Lᵢ with a given threshold value M_{th,L} as shown in Equation (6) below.

$$‖ {L}_{i} - {L}_{i - 1} ≦ {M}_{th , L} \qquad Equation ( 6 )$$

For example, in a case where Equation (6) is satisfied, the training unit 404 judges that the training of an NeRF used to calculate the feature Cᵢ(k, r, w, h) in Equation (5) has converged. The judgment as to whether the training of an NeRF has converged may be performed for each learning target space. For example, letting N_{d,i} denote weight parameters of each node of an NeRF in the training process for the ith iteration in a certain learning target space d, the process of judging whether the training of the NeRF has converged may be performed using, for example, Equation (7) shown below.

$$‖ {N}_{d , i} - {L}_{d , i - 1} ‖ ≦ {M}_{th , N} \qquad Equation ( 7 )$$

Here, the left-hand side represents the amount of reduction in the weight parameters N_{d,i}, and the right-hand side is a given threshold value M_{th,N}. Note that the threshold values M_{th,L} and M_{th,N} on the right-hand sides of Equations (6) and (7) described above may be set by, for example, the setting unit 403. For example, for a learning target space satisfying Equation (7), the training unit 404 judges that the training of an NeRF assigned to the learning target space has converged.

In the above manner, the training unit 404 may judge the convergence of the training of an NeRF using Equation (6) or (7) or the like shown as an example. Through such processes, the learning target spaces may be classified as any one of a learning target space on which the training of an NeRF has already converged by the time of the previous training process in the repetitions of the training process, a learning target space on which the training of an NeRF has newly converged, and a learning target space on which the training of an NeRF has not converged. In the process of S1007, the training unit 404 saves the feature of an NeRF assigned to a learning target space on which the training of an NeRF is judged to have newly converged. Note that, for learning target spaces on which the training of NeRFs has already converged by the time of the previous training process in the repetitions of the training process, the features of the NeRFs do not need to be saved again. However, in a case where the feature of an NeRF is saved for each ray, there may be a case where no feature about some ray has not been saved even in a learning target space on which the training of an NeRF has already converged. In such a case, the feature about a ray used in the process of S1007 may be newly saved.

After the process of S1008, the training unit 404 returns to the process of S1001 and repeatedly executes the processes in the flowchart illustrated in FIG. 10 until it is judged in S1001 that the training of NeRFs assigned to all the learning target spaces has converged.

### <Effects Produced by Image Processing Apparatus>

As described above, in the present embodiment, the image processing apparatus 102 is configured to judge, for each learning target space, the convergence of the training of a NeRF assigned to the learning target space and utilize the feature of one or more NeRFs of which the training has converged to train one or more NeRFs of which the training has not converged. Such an image processing apparatus 102 enables the reduction of the amount of computation needed to estimate a three-dimensional field.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-011334, filed Jan. 27, 2025, which is hereby incorporated by reference herein in its entirety.

What is claimed is:

1. An image processing apparatus comprising:
one or more hardware processors; and
one or more memories storing one or more programs configured to be executed by the one or more hardware processors, the one or more programs including instructions for:
obtaining a plurality of captured images obtained by performing image capturing on a three-dimensional space to be learned from a plurality of directions;
setting a plurality of learning target spaces in the three-dimensional space, assigning, for each learning target space of the learning target spaces, a learning model to be used to estimate a three-dimensional field of the learning target space, and setting, for each learning target space of the learning target spaces, a termination condition of training of a learning model assigned to the learning model;
estimating, based on the termination condition, the three-dimensional field by performing training on a learning model assigned to each learning target space of the learning target spaces using the plurality of captured images; and
performing, in a case where learning models assigned to the learning target spaces include one or more trained learning models and one or more learning models still in training, training on the one or more learning models still in training while performing training on the learning target space to which one of the one or more trained learning models is assigned, using a feature pertaining to the one of the one or more trained learning models, the trained learning models satisfying the termination condition, the learning models still in training not satisfying the termination condition.

2. The image processing apparatus according to claim 1, wherein the one or more programs further include instructions for
setting, as the termination condition, a number of training iterations to each learning model of the learning models assigned to the learning target spaces.

3. The image processing apparatus according to claim 1, wherein the one or more programs further include instructions for
setting, as the termination condition, a number of training iterations to each ray for each learning model of the learning models assigned to the learning target spaces.

4. The image processing apparatus according to claim 2, wherein the one or more programs further include instructions for
setting the number of training iterations in accordance with a type of an object present in the learning target space.

5. The image processing apparatus according to claim 2, wherein the one or more programs further include instructions for
setting the number of training iterations in accordance with a size of an object present in the learning target space.

6. The image processing apparatus according to claim 2, wherein the one or more programs further include instructions for
setting the number of training iterations in accordance with a complexity of a three-dimensional shape of an object present in the learning target space.

7. The image processing apparatus according to claim 2, wherein the one or more programs further include instructions for
setting the number of training iterations in accordance with a position of a given virtual viewpoint, a viewing direction at the viewpoint, and a view angle at the viewpoint.

8. The image processing apparatus according to claim 1, wherein the one or more programs further include instructions for
setting, as the termination condition, a convergence condition of training to each learning model of the learning models assigned to the learning target spaces.

9. The image processing apparatus according to claim 8, wherein
the convergence condition is a threshold value for an amount of change in at least any one of feature pertaining to a learning model assigned to each learning target space of the learning target spaces and loss in an output value of a learning model assigned to each learning target space of the learning target spaces.

10. The image processing apparatus according to claim 1, wherein
a feature pertaining to the learning model is a value representing at least any one of a color, a density, transparency, and opacity at a position in the learning target space.

11. The image processing apparatus according to claim 1, wherein
a feature pertaining to the learning model is a parameter of the learning model assigned to each learning target space of the learning target spaces.

12. The image processing apparatus according to claim 1, wherein
a feature pertaining to the learning model is a value obtained through volume rendering using the learning model assigned to each learning target space of the learning target spaces.

13. The image processing apparatus according to claim 1, wherein
the learning model assigned to each learning target space of the learning target spaces includes at least one of a neural network, a grid, and a distribution function.

14. The image processing apparatus according to claim 1, wherein the one or more programs further include instructions for
setting the plurality of learning target spaces based on positions of objects present in the three-dimensional space.

15. The image processing apparatus according to claim 1, wherein the one or more programs further include instructions for
performing volume rendering using the one or more trained learning models.

16. An image processing method comprising the steps of:
obtaining a plurality of captured images obtained by performing image capturing on a three-dimensional space to be learned from a plurality of directions;
setting a plurality of learning target spaces in the three-dimensional space, assigning, for each learning target space of the learning target spaces, a learning model to be used to estimate a three-dimensional field of the learning target space, and setting, for each learning target space of the learning target spaces, a termination condition of training of a learning model assigned to the learning model;
estimating, based on the termination condition, the three-dimensional field by performing training on a learning model assigned to each learning target space of the learning target spaces using the plurality of captured images; and
performing, in a case where learning models assigned to the learning target spaces include one or more trained learning models and one or more learning models still in training, training on the one or more learning models still in training while performing training on the learning target space to which one of the one or more trained learning models is assigned, using a feature pertaining to the one of the one or more trained learning models, the trained learning models satisfying the termination condition, the learning models still in training not satisfying the termination condition.

17. A non-transitory computer readable storage medium storing a program for causing a computer to perform a control method of an image processing apparatus, the control method comprising the steps of:
obtaining a plurality of captured images obtained by performing image capturing on a three-dimensional space to be learned from a plurality of directions;
setting a plurality of learning target spaces in the three-dimensional space, assigning, for each learning target space of the learning target spaces, a learning model to be used to estimate a three-dimensional field of the learning target space, and setting, for each learning target space of the learning target spaces, a termination condition of training of a learning model assigned to the learning model;
estimating, based on the termination condition, the three-dimensional field by performing training on a learning model assigned to each learning target space of the learning target spaces using the plurality of captured images; and
performing, in a case where learning models assigned to the learning target spaces include one or more trained learning models and one or more learning models still in training, training on the one or more learning models still in training while performing training on the learning target space to which one of the one or more trained learning models is assigned, using a feature pertaining to the one of the one or more trained learning models, the trained learning models satisfying the termination condition, the learning models still in training not satisfying the termination condition.
